(19) United States
(12) Patent Application Publication
(10) Pub. No.: US 2011/0267810 A1
(43) Pub. Date: Nov. 3, 2011

(54) FLOURESCENT LIGHTING FIXTURE AND LUMINAIRE IMPLEMENTING ENHANCED HEAT DISSIPATION

(75) Inventors: David C. Higman, Philadelphia, PA (US); Rajul Desai, Burlington, NJ (US)

(73) Assignee: A.L.P. LIGHTING & CEILING PRODUCTS, INC., Niles, IL (US)

(21) Appl. No.: 12/771,264

(22) Filed: Apr. 30, 2010

(51) Int. Cl. F21V 29/00

(52) U.S. Cl. 362/218; 362/217.08

(57) ABSTRACT

An indoor enclosed fluorescent lighting fixture and luminaire implements enhanced heat dissipation. A lighting fixture includes an upper heat sink housing defining a cavity receiving at least one electrical ballast, and an upwardly open lower lens member receiving a fluorescent light source. The upper heat sink housing has a predefined heat transfer profile including generally flat elongated base wall portions for heat transfer mating engagement with a reflector positioned above the fluorescent light source and a vertically spaced apart, generally centrally located upper wall portion for heat transfer engagement with an electrical ballast.

### FIELD OF THE INVENTION

The present invention relates generally to lighting fixtures and luminaires, and more particularly, relates to an enclosed indoor fluorescent high bay lighting fixture and luminaire for implementing enhanced heat dissipation.

### DESCRIPTION OF THE RELATED ART

Fluorescent luminaires including enclosed and gasketed high bay fixtures provide an excellent light source for the food processing and any other industry that requires a wet location type fixture. The fluorescent luminaires generate the necessary lumens needed for facilities with high ceiling heights. At these heights the ambient temperature typically is much higher than at floor level, due to rising heat.

In the market today there are several enclosed and gasketed fluorescent high bay units with capabilities to operate with 3 to 6 lamps using multiple ballasts. The lamps include available lamp types T8 and T5 high output (HO) fluorescent lamps. It is the 6 lamp T5 54W version that is most susceptible to problems in high ambient temperatures. This lamp and ballast combination provides the necessary lighting for high ceiling application, but generates the most heat.

It is with such higher ambient temperatures where many known enclosed and gasketed fluorescent high bay fixtures fail to adequately dissipate heat. The units are enclosed and gasketed and tend to trap heat generated by the ballast and lamps. The components typically run close to their temperature limits at 25° C. At higher ambient temperature these same components will exceed their temperature limits and potentially fail.

Results from thermal testing of some existing products in the market show that main units do not adequately dissipate heat as needed to maintain proper lamp and ballast temperatures. Instead some fixtures act like an oven and trap heat. Due to poor fixture design the lamp generally heats the ballast compartment like an oven and the radiant heat is unable to escape because the air in the ballast cavity does not allow the heat to conduct to the surface. In addition, the ballast in some existing products is mounted to the same surface as the lamp. Thus direct conduction from the metal surface to the ballast also causes an increase ballast case temperature. Ballast manufacturer assign a maximum temperature that the ballast cannot exceed.

A need exists for new luminaires and enclosed fluorescent high bay fixtures that will resolve these problems.

It is desirable to provide an enclosed fluorescent lighting fixture and luminaire that implements enhanced heat dissipation.

### SUMMARY OF THE INVENTION

A principal aspect of the present invention is to provide an enclosed fluorescent lighting fixture and luminaire for implementing enhanced heat dissipation. Other important aspects of the present invention are to provide such fluorescent lighting fixture and luminaire substantially without negative effect and that overcome many of the disadvantages of prior art arrangements.

In brief, a fluorescent lighting luminaire is provided for implementing enhanced heat dissipation. An enclosed lighting fixture includes an upper heat sink housing defining a cavity receiving at least one electrical ballast, an upwardly open lower lens member receiving a fluorescent light source, and a reflector positioned above the fluorescent light source. The upper heat sink housing has a predefined heat transfer profile including generally flat elongated base wall portions for heat transfer mating engagement with the reflector and a vertically spaced apart, generally centrally located upper wall portion for heat transfer engagement with an electrical ballast. The upper heat sink housing and lower lens member are secured together having cooperating mating perimeter ledge portions arranged in mating engagement.

In accordance with features of the invention, the upper heat sink housing wall portions conduct heat emitted from the fluorescent light source and from the electrical ballast and directly transfers the heat to the outside ambient air through convection.

In accordance with features of the invention, the upper heat sink housing of the lighting fixture is a unitary molded member. The upper heat sink housing is formed of a sheet molding compound (SMC).

In accordance with features of the invention, a heat shield member mounted to the upper heat sink housing above the reflector separates the cavity receiving at least one electrical ballast from a lamp compartment defined by the lower lens member. The heat shield member is formed of a selected material, such as sheet molding compound (SMC).

In accordance with features of the invention, the lower lens member receives to a plurality of fluorescent lamps. A pair of lamp socket bars is mounted to the upper heat sink housing providing electrical connection to the plurality of fluorescent lamps. The lower lens member has a bottom, first and second end walls, and first and second sidewalls defining a lamp compartment. The lower lens member includes a plurality of linear light diffusing ribs formed in opposing elongated sidewalls. The lower lens member is formed of an acrylic blended or polycarbonate material.

In accordance with features of the invention, the reflector includes a pair of reflector members and a center reflector member. The reflector is formed of a selected material, such as aluminum sheet metal for transferring heat and reflecting the light from the plurality of fluorescent lamps downwardly.

In accordance with features of the invention, a pair of brackets mounted in cooperating mating recesses of the upper heat sink housing is used for hanging the fluorescent lighting luminaire. The upper heat sink housing and lower lens member are secured together by a plurality of latches, for example, formed of stainless steel.

In accordance with features of the invention, the lighting fixture includes a heat sink plate mounted within an aperture in the generally central upper wall portion of the upper heat sink housing and at least one electrical ballast mounted to a ballast gear tray is positioned in heat transfer engagement with the heat sink plate. A gasket is seated within the aperture in the upper heat sink housing.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1A is an exploded perspective view not to scale illustrating an enclosed fluorescent high bay fixture in accordance with a preferred embodiment;

FIG. 1B is a schematic and assembled view not to scale illustrating heat transfer of a fluorescent luminaire including the enclosed fluorescent high bay fixture of FIG. 1A in accordance with a preferred embodiment;

FIG. 2A is an exploded perspective view not to scale illustrating another enclosed fluorescent high bay fixture in accordance with another preferred embodiment; and

FIG. 2B is a schematic and assembled view not to scale illustrating heat transfer of a fluorescent luminaire including the enclosed fluorescent high bay fixture of FIG. 2A in accordance with another preferred embodiment.

### DETAILED DESCRIPTION OF THE PREFERRED EMBODIMENTS

In accordance with features of the invention, fluorescent fixtures are provided for implementing enhanced heat dissipation. The fluorescent fixtures utilize various design geometry and unique components to maintain low component temperature.

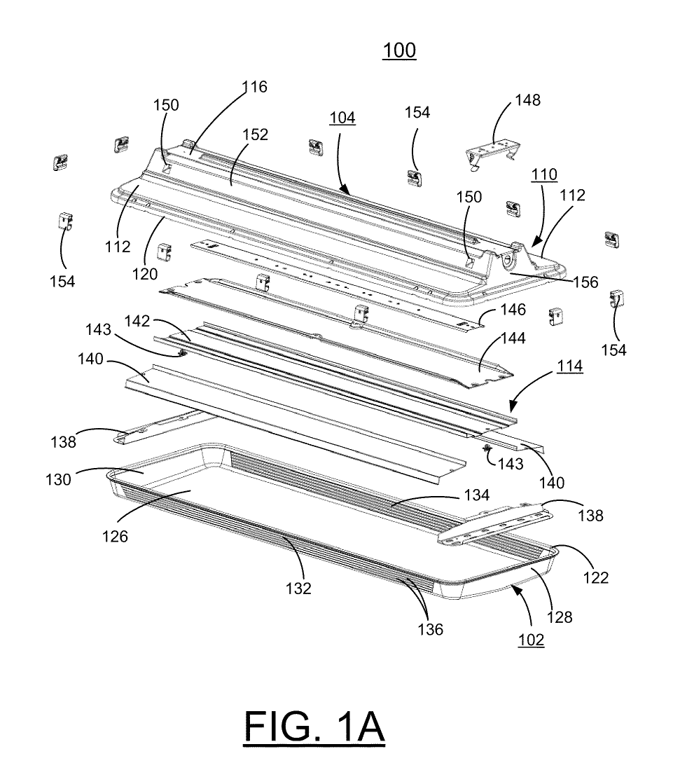

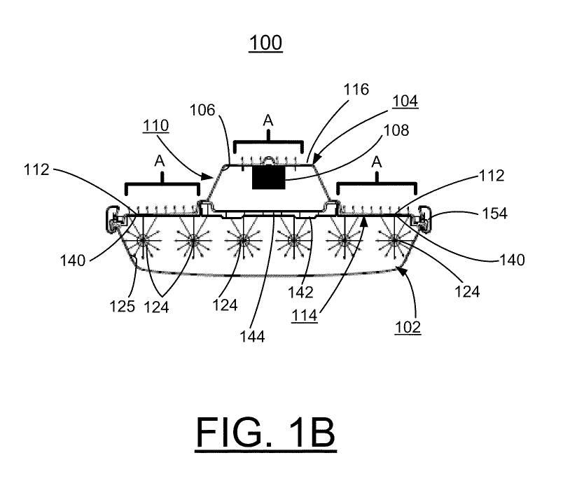

Having reference now to the drawings, in FIGS. 1A and 1B, there is shown an enclosed fluorescent high bay fixture generally designated by the reference character 100 with arrows labeled A representing enhanced heat transfer in FIG. 1B. The enclosed fluorescent high bay fixture 100 includes a lower lens member 102 and an upper housing member 104. The upper housing member 104 defines a cavity 106 receiving one or multiple electrical ballasts 108.

The upper heat sink housing 104 has a predefined heat transfer profile generally designated by the reference character 110 including generally flat elongated base wall portions 112 for heat transfer mating engagement with a reflector generally designated by the reference character 114 and a vertically spaced apart, generally centrally located upper wall portion 116 for heat transfer engagement with the electrical ballast 108. The upper heat sink housing 104 and lower lens member 102 are secured together having respective cooperating mating perimeter ledge portions 120, 122 arranged in mating engagement.

The lower lens 102 is an upwardly open lower lens member receiving a fluorescent light source 124, for example, six (6) fluorescent lamps as shown in FIG. 1B. The upper heat sink housing 104 of the lighting fixture 104 is a unitary molded member, preferably formed of a sheet molding compound (SMC). The sheet molding compound (SMC) is a reinforced fiberglass resin molding compound.

As indicated by multiple arrows labeled A in FIG. 1B, the upper heat sink housing wall portions 112, 116 conduct heat emitted from a fluorescent light source 124 and from the electrical ballast 108 and directly transfer the heat to the outside ambient air through convection.

The lower lens member 102 defines a cavity 125 receiving the fluorescent lamps 124. The lower lens member 102 has a bottom 126, first and second end walls 128, 130, and first and second sidewalls 132, 134 defining the lamp compartment 125. The lower lens member 102 includes a plurality of linear light diffusing ribs 136 formed in the opposing elongated sidewalls 132, 134. The lower lens member 102 is formed, for example, of an acrylic blended or polycarbonate material. The lower lens member 102 receives a plurality of fluorescent lamps 124. A pair of lamp socket bars 138 is mounted to the upper heat sink housing 104 to provide electrical connection to the plurality of fluorescent lamps 124.

The reflector 114 is generally flat including a pair of side reflector members 140, and a center reflector member 142 positioned between the side reflector members 140. The respective side reflector members 140 are provided in heat transfer engagement with the lower housing wall portions 112 of the upper heat sink housing 104. A pair of fasteners 143, such as quarter turn fasteners, secures the center reflector member 142 to the socket bars 138. A heat shield member 144 mounted to the upper heat sink housing 104 and positioned above the center reflector member 142 separates the cavity 106, which receives the electrical ballasts 108, from the lamps 124 in the lamp receiving compartment 125 defined by the lower lens member 102. The reflector 114 including the pair of side reflector members 140, and the center reflector member 142 can be formed of aluminum sheet metal bent to the shaped configurations shown in FIGS. 1A and 1B.

It should be understood that the present invention is not limited to the illustrated configuration of reflector members 140, 142 and heat shield member 144; for example, various configurations of mounting features, and the like, can be used with the reflector members 140, 142, and the head shield member 144, as apparent to those skilled in the art.

The heat shield member 144 is formed of a selected material, such as the same sheet molding compound (SMC) used for forming the upper heat sink housing 104. The enclosed fluorescent high bay fixture 100 includes a heat shield gear tray member 146, for example, formed of a selected material, such as steel. One or multiple electrical ballasts 108 are mounted to the bottom surface of the heat shield gear tray member 146.

The enclosed fluorescent high bay fixture 100 includes a pair of brackets 148 (one shown) mounted in cooperating mating recesses 150 formed in the opposing upper sloping sidewalls 152 of the upper heat sink housing 104. The pair of brackets 148 is used for hanging the fluorescent lighting luminaire 100. The upper heat sink housing 104 and lower lens member 102 are secured together by a plurality of latches 154, for example, formed of stainless steel with a pair of latches 154 provided at opposing housing ends 156 and four latches 154 provided at opposing base wall portions 112.

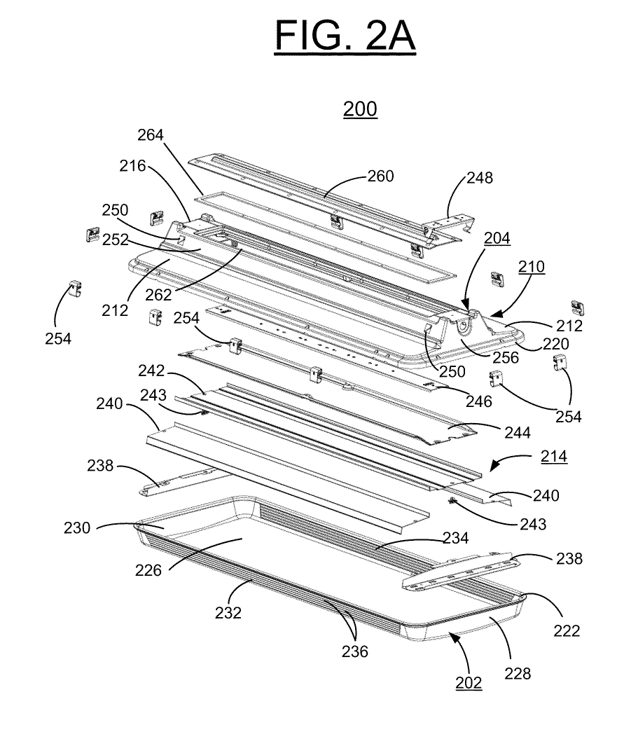

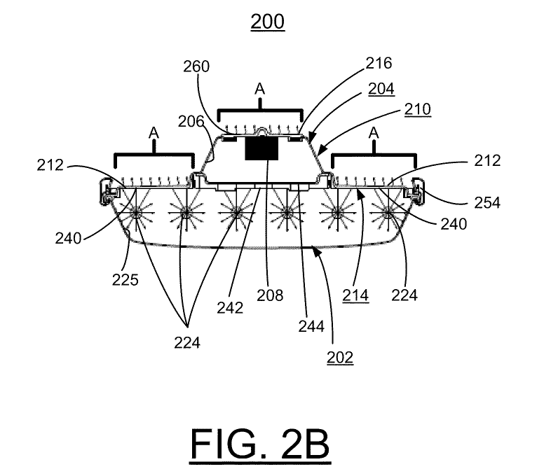

Referring to FIGS. 2A and 2B, there is shown another example enclosed fluorescent high bay fixture generally designated by the reference character 200 in accordance with another preferred embodiment.

In accordance with the embodiment of the invention as illustrated in FIGS. 2A and 2B, the enclosed fluorescent high bay fixture 200 is similar to enclosed fluorescent high bay fixture 100 shown in FIGS. 1A and 1B and includes an additional heat sink plate generally designated by the reference character 260 that is provided to further implement enhanced heat dissipation with arrows labeled A representing enhanced heat transfer in FIG. 2B.

The enclosed fluorescent high bay fixture 200 includes a lower lens member 202 and an upper housing member 204. The upper housing member 204 defines a cavity 206 receiving one or multiple electrical ballasts 208.

The upper heat sink housing 204 has a predefined heat transfer profile generally designated by the reference character 210 including generally flat elongated base wall portions 212 for heat transfer mating engagement with a reflector generally designated by the reference character 214 and a vertically spaced apart, generally centrally located upper wall portion 216 with an aperture 262 receiving the heat sink plate 260 for heat transfer engagement with at least one electrical ballast 208, mounted to a ballast gear tray member 246. An associated mating gasket 264 is seated within the aperture 262. The upper heat sink housing 204 and lower lens member 202 are secured together having respective cooperating mating perimeter ledge portions 220, 222 arranged in mating engagement.

The lower lens 202 is an upwardly open lower lens member receiving a fluorescent light source 224, for example, six (6) fluorescent lamps 224 as shown in FIG. 2B. The upper heat sink housing 204 of the lighting fixture 200 is a unitary molded member, preferably formed of the same sheet molding compound (SMC) used for forming the upper heat sink housing 104.

As indicated by multiple arrows labeled A in FIG. 2B, the upper heat sink housing wall portions 212, and the heat sink plate 206 and housing wall portion 216 conduct heat emitted from the fluorescent light source 224 and from the electrical ballast 208 and directly transfer the heat to the outside ambient air through convection.

The lower lens member 202 defines a cavity 225 receiving the fluorescent lamps 224. The lower lens member 202 has a bottom 226, first and second end walls 228, 230, and first and second sidewalls 232, 234 defining the lamp compartment 225. The lower lens member 202 includes a plurality of linear light diffusing ribs 236 formed in opposing elongated sidewalls 232, 234. The lower lens member 202 is formed, for example, of an acrylic blended or polycarbonate material. The lower lens member 202 receives a plurality of fluorescent lamps 224. A pair of lamp socket bars 238 is mounted to the upper heat sink housing 204 to provide electrical connection to the plurality of fluorescent lamps 224.

The reflector 214 is generally flat including a pair of side reflector members 240, and a center reflector member 242 positioned between the side reflector members 240. The respective side reflector members 240 are provided in heat transfer engagement with the lower housing wall portions 212 of the upper heat sink housing 204. A pair of fasteners 243, such as quarter turn fasteners, secures the center reflector member 242 to the socket bars 238. A heat shield member 244 mounted to the upper heat sink housing 204 and positioned above the center reflector member 242 separates the cavity 206, which receives the electrical ballasts 208, from the lamps 224 in the lamp receiving compartment 225 defined by the lower lens member 202. The reflector 214 including the pair of side reflector members 240, and the center reflector member 242 can be formed of aluminum sheet metal bent to the shaped configurations shown in FIG. 2B.

It should be understood that the present invention is not limited to the illustrated configuration of reflector members 240, 242 and heat shield member 244; for example, various configurations of mounting features, and the like, can be used with the reflector members 240, 242, and the head shield member 244, as apparent to those skilled in the art.

The heat shield member 244 is formed of a selected material, such as the same sheet molding compound (SMC) used forming the upper heat sink housing 204. The enclosed fluorescent high bay fixture 200 includes a heat shield gear tray member 246, for example, formed of a selected material, such as steel. One or multiple electrical ballasts 208 are mounted to the bottom surface of the heat shield gear tray member 246.

The enclosed fluorescent high bay fixture 200 includes a pair of brackets 248 (one shown) mounted in cooperating mating recesses 250 formed in the opposing upper sloping sidewalls 252 of the upper heat sink housing 204. The pair of brackets 248 is used for hanging the fluorescent lighting luminaire 200. The upper heat sink housing 204 and lower lens member 202 are secured together by a plurality of latches 254, for example, formed of stainless steel with a pair of latches 254 provided at opposing housing ends 256 and four latches 254 provided at opposing base wall portions 212.

In summary, the fluorescent high bay fixtures 100, 200 of the invention are designed to conduct the lamp and ballast heat to the top surface of the respective heat sink housing 104, 204 and transfer heat to the air through convection. A major difference between the enclosed and gasketed fluorescent high bay fixtures 100, 200 of the invention and conventional arrangements is that the heat from the lamps 124, 224 is conducted to the heat sink housing 104, 204 and transferred to the surrounding air through convection. The insulating gap of air between the gear tray and the lamps found in many conventional arrangements has been eliminated. Heat emitted from the lamps 124, 224 is conducted through direct contact of the reflector 114, 214 through the heat sink housing 104, 204. In addition, the fluorescent high bay fixture 100, 200 of the invention provides the heat shield 144, 244, and the additional heat sink member 260, which minimizes the amount of radiant heat emitted from a metal ballast cover of the electrical ballast 208. With the heat shield 144, 244, and the heat sink member 260 in place, the ballast 208 is exposed to less radiant heat and thus operates cooler. A reduction in ballast temperature is attributed to the heat shield 144, 244, and to the heat sink member 260 being heat sunk to the housing surface 216. The heat transfer contact between the ballast 208 mounted to the ballast gear tray member 246 and the heat sink member 260 facilitates the heat conduction process. The fluorescent high bay fixtures 100, 200 of the invention overcome disadvantages of many known commercially available fixtures, for example, which mount the ballast and the lamps to the same pan, resulting in the heat generated by the lamps conducting directly to the ballast.

While the present invention has been described with reference to the details of the embodiments of the invention shown in the drawing, these details are not intended to limit the scope of the invention as claimed in the appended claims.

What is claimed is:

1. An enclosed fluorescent lighting fixture for implementing enhanced heat dissipation comprising:
an upper heat sink housing defining a cavity receiving at least one electrical ballast,
an upwardly open lower lens member receiving a fluorescent light source;
a reflector positioned above the fluorescent light source;
said upper heat sink housing having a predefined heat transfer profile including generally flat elongated base wall portions for heat transfer mating engagement with said reflector and a vertically spaced apart, generally centrally located upper wall portion for heat transfer engagement with said at least one electrical ballast; and
said upper heat sink housing and lower lens member being secured together, having cooperating mating perimeter ledge portions arranged in mating engagement.

2. The enclosed fluorescent lighting fixture for implementing enhanced heat dissipation as recited in claim 1 wherein said upper heat sink housing is a unitary member.

3. The enclosed fluorescent lighting fixture for implementing enhanced heat dissipation as recited in claim 1 wherein said upper heat sink housing is formed of a sheet molding compound (SMC).

4. The enclosed fluorescent lighting fixture for implementing enhanced heat dissipation as recited in claim 3 wherein said sheet molding compound (SMC) includes a reinforced fiberglass resin molding compound.

5. The enclosed fluorescent lighting fixture for implementing enhanced heat dissipation as recited in claim 1 includes a heat shield member mounted to said upper heat sink housing above said reflector; said heat shield member separates said cavity receiving said at least one electrical ballast from said fluorescent light source received in said lower lens member.

6. The enclosed fluorescent lighting fixture for implementing enhanced heat dissipation as recited in claim 5 wherein said heat shield member is formed of a sheet molding compound (SMC).

7. The enclosed fluorescent lighting fixture for implementing enhanced heat dissipation as recited in claim 1 wherein said lower lens member includes a plurality of linear light diffusing ribs formed in opposing elongated sidewalls.

8. The enclosed fluorescent lighting fixture for implementing enhanced heat dissipation as recited in claim 1 wherein said lower lens member is formed of a selected material of an acrylic blended material and a polycarbonate material.

9. The enclosed fluorescent lighting fixture for implementing enhanced heat dissipation as recited in claim 1 wherein said reflector includes a pair of side reflector members and a center reflector member.

10. The enclosed fluorescent lighting fixture for implementing enhanced heat dissipation as recited in claim 1 wherein said fluorescent light source includes a plurality of fluorescent lamps.

11. The enclosed fluorescent lighting fixture for implementing enhanced heat dissipation as recited in claim 1 wherein said reflector transferring heat from said fluorescent light source outside the lighting fixture through said generally flat elongated base wall portions and said reflector reflecting emitted light from said fluorescent light source downwardly.

12. The enclosed fluorescent lighting fixture for implementing enhanced heat dissipation as recited in claim 1 wherein said reflector is formed of aluminum sheet metal.

13. The enclosed fluorescent lighting fixture for implementing enhanced heat dissipation as recited in claim 1 includes a heat sink plate mounted within an aperture in the generally central upper wall portion of the upper heat sink housing and said at least one electrical ballast is mounted to a ballast gear tray, and provided in heat transfer engagement with said heat sink plate.

14. The enclosed fluorescent lighting fixture for implementing enhanced heat dissipation as recited in claim 13 includes a gasket seated within said aperture.

15. The enclosed fluorescent lighting fixture for implementing enhanced heat dissipation as recited in claim 13 wherein said heat sink plate is formed of aluminum.

16. An enclosed fluorescent lighting luminaire comprising:
an upper heat sink housing defining a cavity receiving at least one electrical ballast,
a fluorescent light source;
an upwardly open lower lens member receiving said fluorescent light source;
a reflector positioned above the fluorescent light source;
said upper heat sink housing having a predefined heat transfer profile including generally flat elongated base wall portions for heat transfer mating engagement with said reflector and a vertically spaced apart, generally centrally located upper wall portion for heat transfer engagement with said at least one electrical ballast; and
said upper heat sink housing and said lower lens member being secured together, having cooperating mating perimeter ledge portions arranged in mating engagement.

17. An enclosed fluorescent lighting luminaire as recited in claim 16 includes a heat shield member mounted to said upper heat sink housing above said reflector; said heat shield member positioned below said cavity receiving said at least one electrical ballast from said fluorescent light source received in said lower lens member.

18. An enclosed fluorescent lighting luminaire as recited in claim 17 wherein said heat shield member is a unitary member formed of a sheet molding compound (SMC).

19. An enclosed fluorescent lighting luminaire as recited in claim 14 wherein said upper heat sink housing is a unitary member, and said upper heat sink housing is formed of a sheet molding compound (SMC).

20. An enclosed fluorescent lighting luminaire as recited in claim 16 includes a heat sink plate mounted within an aperture in the generally central upper wall portion of the upper heat sink housing and said at least one electrical ballast is mounted to a ballast gear tray, and provided in heat transfer engagement with said heat sink plate.
